(19) United States
(12) Patent Application Publication
(10) Pub. No.: US 2020/0307048 A1
(43) Pub. Date: Oct. 1, 2020

(54) MOLDS FOR MAKING PROTECTIVE COVERINGS OVER METAL STRUCTURES

(71) Applicant: HubbellI Incorporated, Shelton, CT (US)

(72) Inventors: William Morrissey, Tulsa, OK (US); Richard Wallace Ceass, Tulsa, OK (US); Adam Britton Polcha, Milwaukie, OR (US)

(21) Appl. No.: 16/831,368

(22) Filed: Mar. 26, 2020

Related U.S. Application Data
(60) Provisional application No. 62/823,725, filed on Mar. 26, 2019.

(51) Int. Cl. B29C 45/14; B29C 45/26

(52) U.S. Cl. CPC B29C 45/14336; B29C 45/26

(57) ABSTRACT

The present disclosure provides protective coverings formed by releasably attaching a mold to a metal structure over a connection, such as an exothermic or brazed connection, and injecting a hardening material into one or more fill ports in the mold. The hardening material hardens to form the protective covering encasing the connection.

### CROSS-REFERENCE TO RELATED APPLICATIONS

The present disclosure is based on and claims benefit from co-pending U.S. Provisional Patent Application Ser. No. 62/823,725 filed on Mar. 26, 2019 entitled “Protective Coverings for Wire Connections” the contents of which are incorporated herein in their entirety by reference.

### BACKGROUND

### Field

The present disclosure generally relates to protective coverings for covering welded connections to metal structures and for patching metal structures. More particularly, the present disclosure relates to molds and hardening materials that when applied to welded connections or outer surfaces of a metal structures harden to form a protective covering over the connections and patching the outer surfaces.

### Description of the Related Art

Buried steel structures are historically protected from decaying using two systems. The first is called a cathodic protection system, that provides a DC current to the steel structure through an anode and a conductive electrolyte. To reduce the amount of cathodic protection needed to protect the steel structure, the surface of the steel structure is usually coated with a dielectric coating that is semi-conductive in nature, which permits the DC current applied by the cathodic protection system to be reduced while still protecting the metal structure.

During the construction and maintenance of underground steel structures, the steel structures are checked for holes in the coating on the surface of the steel structure and also the steel structure is attached to the cathodic protection system by means of welding or braising. Both of these processes find or create holes in the coating on the surface of the steel structure that have to be repaired. The holes found in the coating are currently repaired in an ad hoc manner by roughing up the existing coating and applying a patch coating over top of it. Holes in the coating created while welding or braising are also repaired in a variety of ways. They are sometimes coated on in an ad hoc manner as a patch as described above.

The present disclosure provides a mold and coating material and an improved process for patching holes in the coating on the surface of metal structures and for covering holes in the coating created while welding or braising.

### SUMMARY

The present disclosure provides embodiments of protective coverings over certain connections and to molds used to form the protective coverings. Initially, a mold is positioned over the connection, e.g., an exothermic, brazed or mechanical connection, between one or more electrical conductors and a metal structure. Once the mold is positioned over the connection it is adhered to the metal structure, and a hardening material is injected into one or more fill holes or ports in the mold. The hardening material is then allowed to harden to form the protective covering encasing the connection and a portion of the conductor. The mold may then be removed to reveal the protective covering or the mold may be left in place over the protective covering.

In one exemplary embodiment the mold includes a base and a fill housing. The base is configured and dimensioned to rest on a structure such that there is a pocket between the structure and the base. The fill housing extends from the base and includes a connector portion and a conductor portion. The connector portion has a cavity configured to receive the connection between the conductor and the metal structure. The conductor portion has a tunnel in communication with the cavity and configured to receive the conductor extending from the connection.

In another exemplary embodiment, the mold includes a base and a fill housing. The base has an upper surface and a lower surface. The base is configured and dimensioned so that the lower surface rests on a structure such that there is a pocket between the structure and the base. The fill housing extends from the upper surface of the base and is monolithically formed into the base. The fill housing has a connector portion and a conductor portion. The connector portion has a cavity accessible from the lower surface of the base that is configured to receive the connection between the conductor and the metal structure. The conductor portion has a tunnel accessible from the lower surface of the base and in communication with the cavity. The conductor portion is configured to receive the conductor extending from the connection.

The present disclosure also provides embodiments of methods for forming the protective coverings over certain connections, such as exothermic, brazed or mechanical connections between one or more conductors and a metal structure. In an exemplary embodiment, the method includes adhering a mold to the metal structure such that the mold is positioned over a connection so that the connection is within a fill housing of the mold and one or more conductors pass through a tunnel in the mold and exit the mold. A hardening material is injected into the fill housing through one or more fill holes in the mold so that the hardening material fills the cavity and the tunnel and expands to an area under a base of the mold to at least cover bare metal exposed when preparing a surface of the metal structure for the connection. Expanding the hardening material to an area under a base of the mold and toward the outer perimeter of the base to at least cover the exposed bare metal replaces the coating on the surface of the metal structure removed to make the connection. In the event pressure relief holes are included in the mold, when the hardening material is visible through pressure relief holes sufficient hardening material has been injected into the cavity, the tunnel and the area under the base of the mold adjacent the outer perimeter of the base covering the exposed bare metal of the metal structure. The hardening material is allowed to harden. Once the hardening material hardens, the mold can be peeled off the metal structure to reveal the protective covering.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a perspective view of an exemplary embodiment of a mold used when forming the protective covering according to the present disclosure, illustrating a base and a fill housing extending from the base;

FIG. 2 is a top plan view of the mold of FIG. 1, illustrating the fill housing having a fill port through a top surface of the fill housing;

FIG. 3 is a bottom plan view of the mold of FIG. 1, illustrating the fill housing cavity;

FIG. 4 is a side elevation view of the mold of FIG. 1, illustrating the fill housing having a connection portion and a conductor portion;

FIG. 5 is a perspective view of the mold of FIG. 1 attached to a metal structure;

FIG. 6 is a perspective view of another exemplary embodiment of a mold used when forming the protective covering according to the present disclosure, illustrating a base and a fill housing extending from the base;

FIG. 7 is a top plan view of the mold of FIG. 6, illustrating the fill housing having a fill port through a top surface of the fill housing;

FIG. 8 is a bottom plan view of the mold of FIG. 6;

FIG. 9 is a side elevation view of the mold of FIG. 6, illustrating the fill housing having a connection portion and a conductor portion;

FIG. 10 is a front elevation view of the mold of FIG. 6, illustrating a seam in the conductor portion of the fill housing that permits a conductor to pass through the mold;

FIG. 11 is a top plan view of an exemplary embodiment of a template used to set boundaries for preparing the surface of the metal structure for the protective covering;

FIGS. 12 and 13 are flow diagrams for an exemplary process for installing the mold of FIG. 1 and hardening material for forming a protective covering;

FIGS. 14-23 are exemplary illustrations associated with the process for installing the mold and hardening material of FIGS. 12 and 13;

FIG. 24 is a perspective view of another exemplary embodiment of a mold according to the present disclosure, illustrating a base of the mold and a fill housing;

FIG. 25 is a top plan view of the mold of FIG. 24;

FIG. 26 is a bottom plan view of the mold of FIG. 24;

FIG. 27 is a flow diagram for an exemplary process for installing the mold of FIG. 24 and hardening material for forming the protective patch;

FIG. 28 is a perspective view of the mold of FIG. 24 attached to a metal pipe with hardening material being injected into the mold.

### DETAILED DESCRIPTION

The present disclosure relates to methods for forming protective coverings for buried metal structures. The present disclosure also relates to molds used to form the protective coverings on metal structures. For example, the protective covering may cover dissimilar metal connection points that may be exothermically welded, brazed or mechanical connections between one or more electrical conductors and a metal structure. The metal connection points may also be referred to herein as the “connections” in the plural and the “connection” in the singular. The protective coverings are formed by releasably attaching a mold to a metal structure over the connection and injecting a hardening material into one or more fill holes or ports in the mold. The hardening material hardens to form the protective covering encasing the connection, and the mold may be removed to reveal the protective covering or the mold may be left in place. Non-limiting examples of the metal structures contemplated by the present disclosure include metal pipes and metal storage tanks. The metal structures may be made of, for example, ductile iron, steel, stainless steel, copper or aluminum, and they may be covered with a fusion bonded epoxy (FBE) powder coating, natural and synthetic rubbers, and epoxies. The metal structures may also be referred to herein as the “structures” in the plural and the “structure” in the singular.

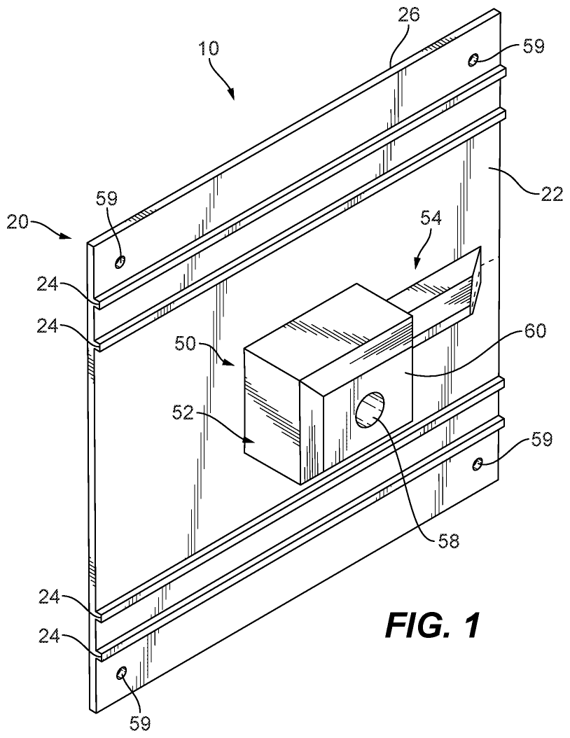

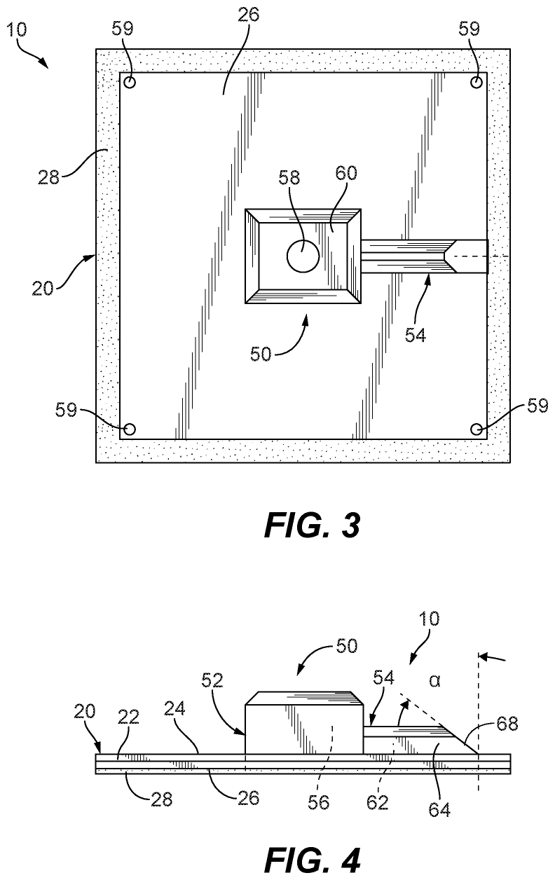

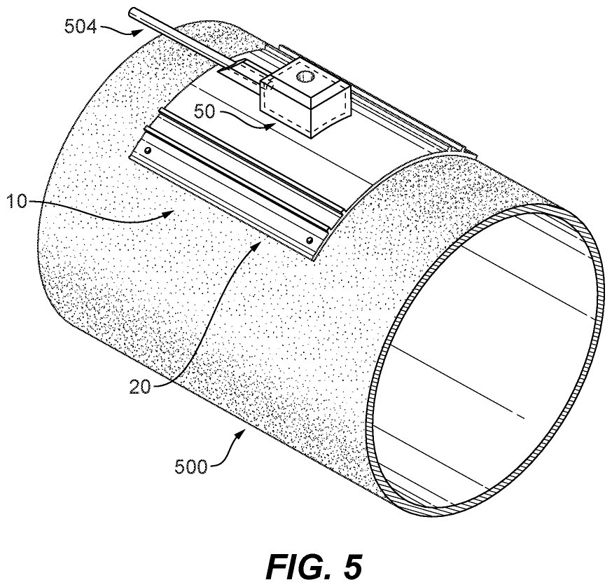

Referring to FIGS. 1-5, an exemplary embodiment of a mold according to the present disclosure is shown. The mold 10 includes a base 20 and a fill housing 50. The base 20 is configured to rest and releasably adhere to a structure 500, seen in FIG. 5. The base 20 and fill housing 50 may be made of a plastic material, such as a plastic material that can be vacuum formed or thermoformed, including thermoplastic or thermo-softening plastic materials. Preferably, the base 20 and fill housing 50 are made of a transparent material so that an installer can visually observe the hardening material being injected into the mold 10. However, the base 20 and fill housing 50 can be made of a material that is not transparent. The base 20 may be in any suitable shape, such as a square shape, a rectangular shape, round shape, elliptical shape, oval shape, or any asymmetrical shape. Preferably, the base 20 is a flexible member that can be manipulated to conform at least partially to the shape of the structure 500 the base is to be releasably adhered to. In the exemplary embodiment shown, the base is square in shape and can flex or bend to conform to the shape of a structure 500, here a pipe, as shown in FIG. 5. The base 20 has an upper surface 22 that may include one or more ribs 24 that provide flex lines or points on the base further permitting the base 20 to flex to conform to the shape of the structure 500. The one or more ribs 24 extend from one edge of the base 20 to an opposite edge of the base 20, as shown. The base 20 has a lower surface 26 that includes a layer 28, seen in FIG. 3, of adhesive at least around a perimeter of the base 20 and release paper 30, seen in FIG. 18, that covers the adhesive layer 28 until the mold is ready for installation. The adhesive layer 28 should be sufficient to releasably adhere the mold 10 to the structure 500. In the exemplary embodiment shown, the width of the adhesive layer 28 is about 0.25 inch. However, the width of the adhesive layer 28 may vary. For example, the width of the adhesive layer 28 may be about 0.5 inch, 0.75 inch or 1 inch. Non-limiting examples of suitable adhesives for the adhesive layer include butyl adhesive tapes and double sided tapes. It is noted that the adhesive layer 28 may be replaced with a magnetic strip along the perimeter of the base 20 that releasably adheres the base to the surface of the metal structure. The width of the magnetic strip may vary. For example, the width of the magnetic strip may be about 0.5 inch, 0.75 inch or 1 inch. The base may include one or more pressure relief holes 59 at or near the outer perimeter of the base. The pressure release holes 59 are used as an air outlet so that as the hardening material is injected into the mold 10 and begins to fill the space or pocket between the mold and the structure 500, air can escape the space via the pressure relief holes 59. In instances where the mold 10 is made of a non-transparent material, the pressure relief holes 59 may also act as an indicator to provide an indication when the hardening material is fully injected into the fill housing 50 and a surrounding perimeter of the fill housing 50 at least any bare metal exposed when preparing the metal structure for the connection.

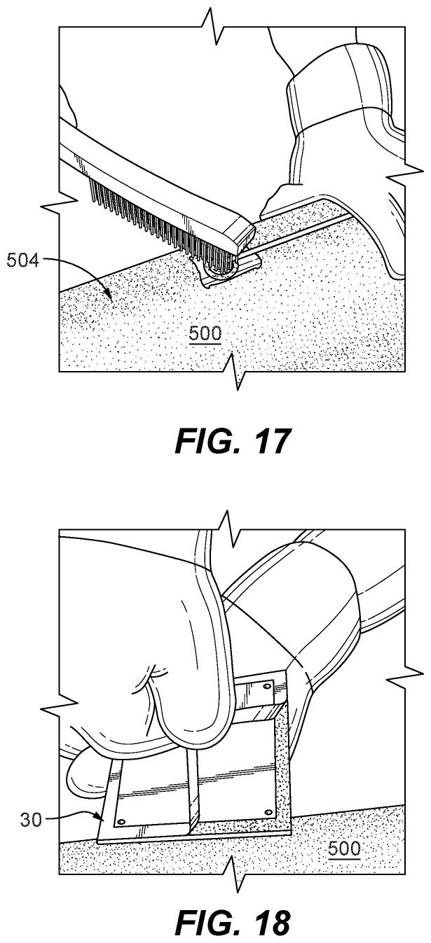

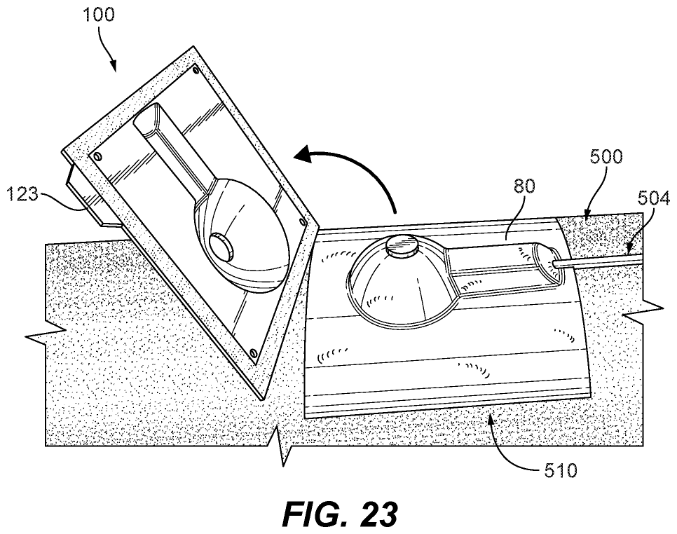

Continuing to refer to FIGS. 1-5, the fill housing 50 of the mold 10 is preferably integrally or monolithically formed into the base 20. However, the fill housing 50 may be secured to the upper surface 22 of the base 20 using, for example, adhesives or welds, e.g., sonic welds. The fill housing 50 has a connection portion 52 and a conductor portion 54. The connection portion 52 has one or more walls that form a cavity 56, seen in FIG. 4, that can receive a connection 502, seen in FIG. 17. The connection portion 52 may include one or more fill holes 58 in, for example, a top wall 60 of the connection portion 52 that permit hardening material 80, seen in FIG. 23, to be injected into the cavity 56 of the connection portion 52 using for example a push applicator 82, seen in FIG. 22.

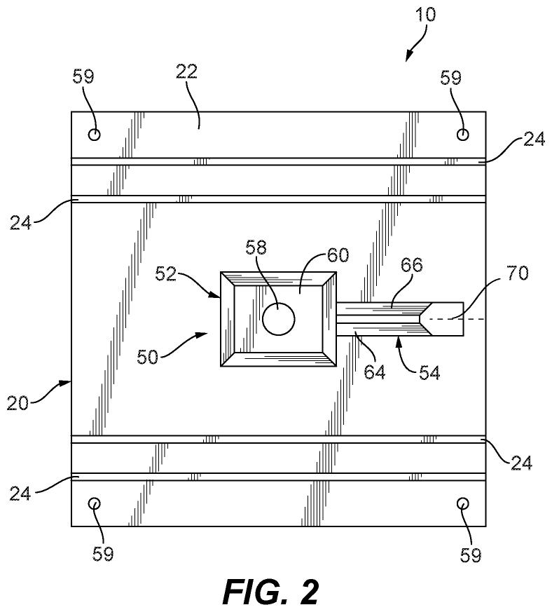

The conductor portion 54 has one or more walls that form a tunnel or cavity 62, seen in FIG. 4, that can receive the one or more electrical conductors 504, seen in FIGS. 16 and 17. The electrical conductors may also be referred to herein as the “conductors” in the plural and the “conductor” in the singular. The tunnel 62 is preferably in communication with the cavity 56 in the connection portion 52 such that hardening material 80 injected into the connection portion 52 can flow into and fill the tunnel 62 in the conductor portion 54. However, the conductor portion 54 may include one or more fill holes (not shown) that are similar to fill holes 58. The fill holes in the conductor portion 54 may be in, for example, side wall 64 or 66 of the conductor portion. The one or more fill holes in the conductor portion 54 would permit the hardening material 80, seen in FIG. 22, to be injected into the tunnel 62 of the conductor portion 54 using, for example, a push applicator 82, seen in FIG. 22. In this exemplary embodiment, a front wall 68 in the conductor portion 54 may be angled relative to the top surface 22 of the base 20. The angle “a” may range from about 20 degrees to about 90 degrees. The front wall 68 in the conductor portion 54 and possibly a portion of the base 20 adjacent the front wall 68 may also include a seam 70, seen in FIG. 2, that can separate to permit the one or more conductors 504 to pass through the mold 10.

It is noted that when the fill housing 50 is integrally or monolithically formed into the base 20, the cavity 56 and tunnel 62 are at the lower surface 26 of the base 20. When the fill housing 50 is secured to the upper surface 22 of the base 20, the base 20 would include an opening that preferably conforms to the cavity 56 and tunnel 62 so that the cavity 56 and tunnel 62 are accessible from the lower surface 26 of the base 20.

The hardening materials contemplated by the present disclosure are preferably dielectric materials that include surface coating resins and like materials, including but not limited to liquid or near liquid adhesive materials such as epoxies, bituminous, asphaltic, polyethylene, synthetic rubbers and wax based materials that can be injected into the fill holes 58 in the fill housing 50 and then harden. An example of a suitable hardening material is the SP-2888® R.G. surface coating resin manufactured and sold by Specialty Polymer Coatings, Inc. of British Columbia, Canada.

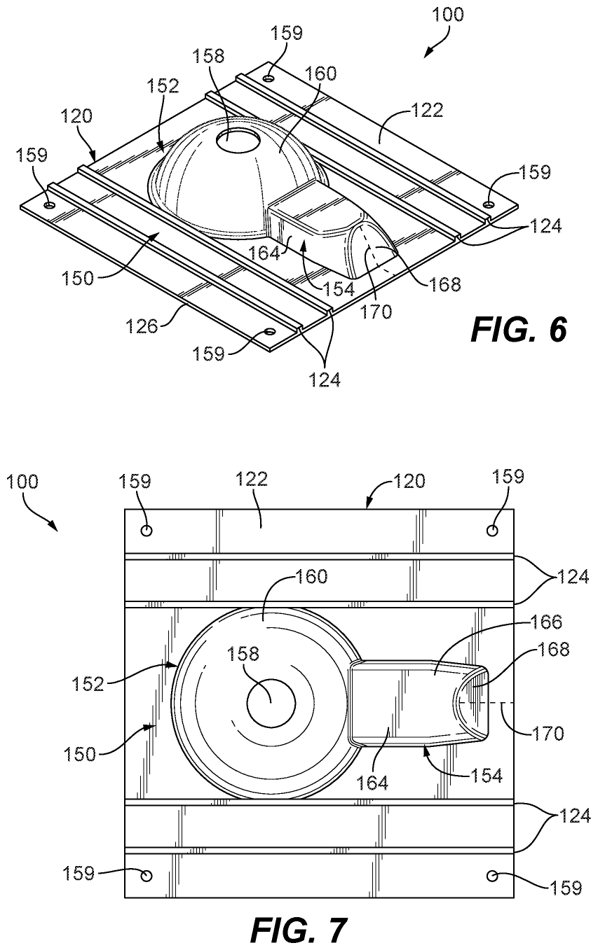

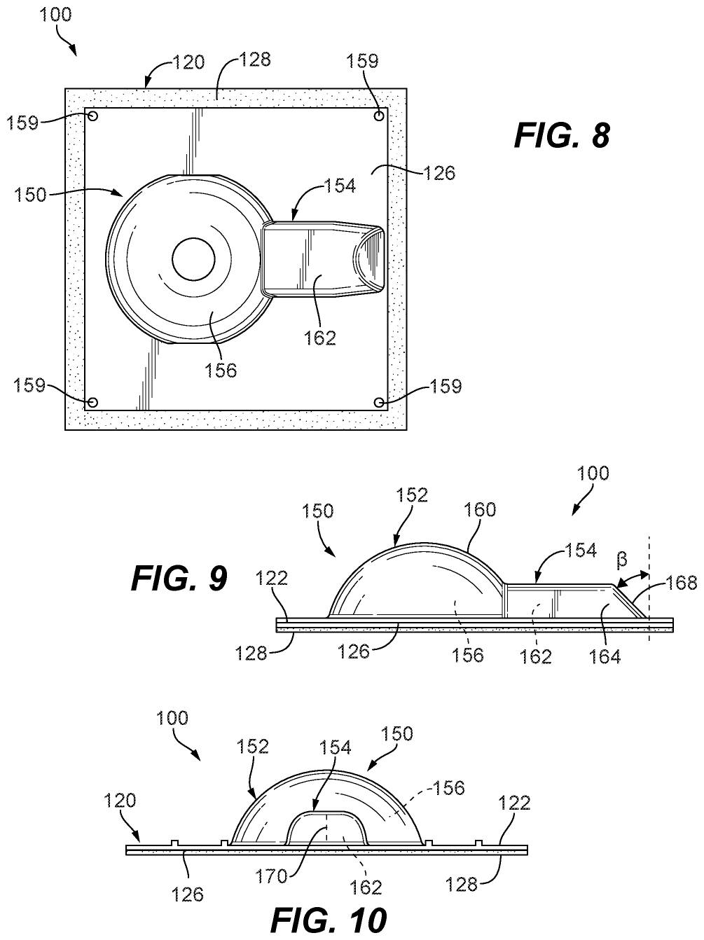

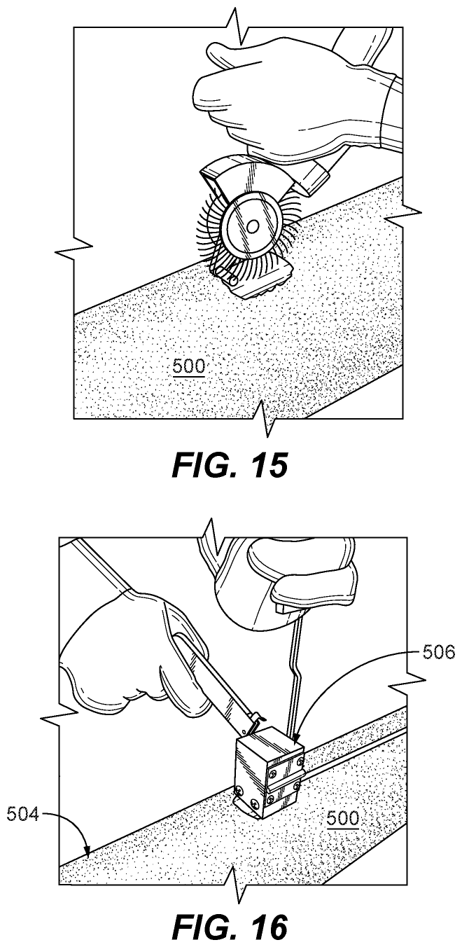

Referring to FIGS. 6-10, another exemplary embodiment of a mold according to the present disclosure is shown. The mold 100 includes a base 120 and a fill housing 150. The base 120 is configured to rest and releasably adhere to a structure 500, seen in FIG. 15. The base 120 and fill housing 150 may be made of a plastic material, such as a plastic material that can be vacuum formed or thermoformed, including thermoplastic or thermo-softening plastic materials. Preferably, the base 120 and fill housing 150 are made of a transparent material so that an installer can visually observe the hardening material being injected into the mold 100. However, the base 120 and fill housing 150 can be made of a material that is not transparent. The base 120 may be in any suitable shape, such as a square shape, a rectangular shape, round shape, elliptical shape, oval shape, or any asymmetrical shape. Preferably, the base 120 is a flexible member that can be manipulated to conform at least partially to the shape of the structure 500 the base is to be releasably adhered to. In the exemplary embodiment shown, the base is square in shape and can flex or bend to conform to the shape of a structure 500, here a pipe, as shown in FIG. 15. The base 120 has an upper surface 122 that may include one or more ribs 124 that provide flex lines or points on the base further permitting the base 120 to flex to conform to the shape of the structure 500. The one or more ribs 124 extend from one edge of the base 120 to an opposite edge of the base 120, as shown. The base 120 has a lower surface 126, seen in FIG. 8, that includes a layer 128 of adhesive at least around a perimeter of the base 20 and release paper that is similar to release paper 30 seen in FIG. 18, that covers the adhesive layer 128 until the mold 100 is ready for installation. The adhesive layer 128 should be sufficient to releasably adhere the mold 100 to the structure 500. In the exemplary embodiment shown, the width of the adhesive layer 128 is about 0.25 inch. However, the width of the adhesive layer 128 may vary. For example, the width of the adhesive layer 128 may be about 0.5 inch, 0.75 inch or 1 inch. Non-limiting examples of suitable adhesives for the adhesive layer 128 include butyl adhesive tapes and double sided tapes. It is noted that the adhesive layer 128 may be replaced with a magnetic strip along the perimeter of the base 120 that releasably adheres the base to the surface of the metal structure 500. The width of the magnetic strip may vary. For example, the width of the magnetic strip may be about 0.5 inch, 0.75 inch or 1 inch. The outer edges of the base may include one or more pressure relief holes 159 used to provide an indication when the hardening material 80 is fully injected into the fill housing and covering at least any bare metal exposed when preparing the metal structure for the connection, as described below. The one or more pressure relief holes 159 also provide an air outlet so that as the hardening material is injected into the mold 100 and begins to fill the space between the mold and the structure 500, air can escape the space via the pressure relief holes 159.

Continuing to refer to FIGS. 6-10, the fill housing 150 of the mold 100 is preferably integrally or monolithically formed into the base 120. However, the fill housing 150 may be secured to the upper surface 122 of the base 120 using, for example, adhesives or welds, e.g., sonic welds. The fill housing 150 has a connection portion 152 and a conductor portion 154. In this exemplary embodiment, the connection portion 152 has a dome shaped wall 160 that forms a cavity 156, seen in FIG. 9, that can receive a connection 502, seen in FIG. 17. The connection portion 152 may include one or more fill holes 158 in, for example, the dome shaped wall 160 that permits hardening material 80, seen in FIGS. 22 and 23, to be injected into the cavity 156 of the connection portion 152 using for example a push applicator 82, seen in FIG. 22.

The conductor portion 154 has one or more walls that form a tunnel or cavity 162, seen in FIG. 9, that can receive the one or more electrical conductors 504, seen in FIGS. 16 and 17. The tunnel 162 is preferably in communication with the cavity 156 in the connection portion 152 such that hardening material 80 injected into the connection portion 152 can flow into and fill the tunnel 162 in the conductor portion 154. However, the conductor portion 154 may include one or more fill holes (not shown) that are similar to fill holes 158. The fill holes in the conductor portion 154 may be in, for example, side wall 164 or 166 of the conductor portion. The one or more fill holes in the conductor portion 154 would permit the hardening material 80, seen in FIGS. 22 and 23, to be injected into the tunnel 162 of the conductor portion 154. A front wall 168 in the conductor portion 154, in this exemplary embodiment, maybe angled relative to the top surface 122 of the base 120. The angle “β” may range from about 20 degrees to about 90 degrees. The front wall 168 in the conductor portion 154 and possibly a portion of the base 120 adjacent the front wall 168 may also include a seam 170, seen in FIGS. 6 and 7, that can separate to permit the one or more conductors 504 to pass through the mold 100.

It is noted that when the fill housing 150 is integrally or monolithically formed into the base 120, the cavity 156 and tunnel 162 are at the lower surface 126 of the base 120. When the fill housing 150 is secured to the upper surface 122 of the base 120, the base 120 would include an opening that preferably conforms to the cavity 156 and tunnel 162 so that the cavity 156 and tunnel 162 are accessible from the lower surface 126 of the base 120.

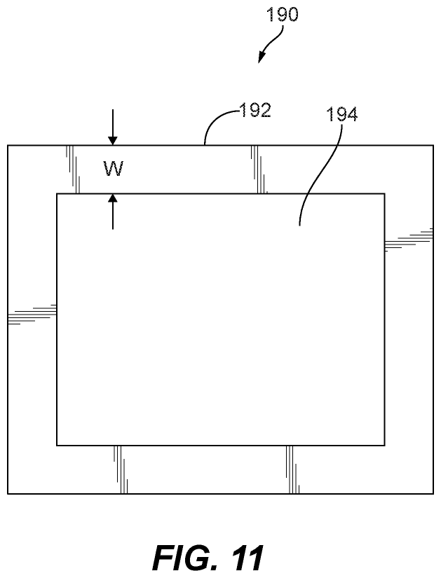

Referring to FIG. 11, an exemplary embodiment of a template 190 that can be used when preparing the surface of the metal structure 500 for the connection 502 and the mold 10 or 100. The template 90 may be in any suitable shape, such as a square shape, a rectangular shape, round shape, elliptical shape, oval shape, or any asymmetrical shape. The template 190 has an outer border 192 with a predefined width “W” and an inner opening 194. The width of the outer border 192 may vary in size depending upon the size of the base of the mold and the size of the fill housing. In the exemplary embodiment of FIG. 11, the width of the outer border 192 is about 1 inch. The outer border 192 of the template 190 represents the portion of the metal structure 500 that the adhesive layer 28 or 128 of the mold will adhere to. The inner opening 194 of the template 190 may be any suitable shape, such as a square shape, a rectangular shape, round shape, elliptical shape, oval shape, or any asymmetrical shape, and represents the portion of the metal structure 500 that is stripped to bare metal, described below, to receive the connection 502. Preferably, the template 190 is a flexible member that can be manipulated to conform at least partially to the shape of the structure 500. To releasable attach the template 190 to the metal structure, the template 190 is preferably made of a flat magnetic material.

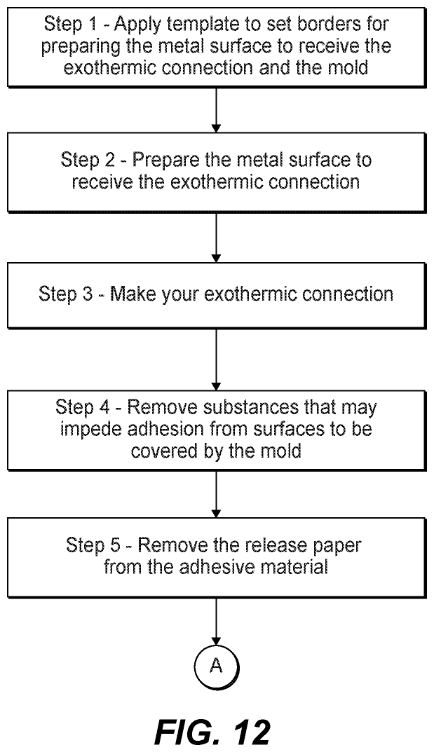

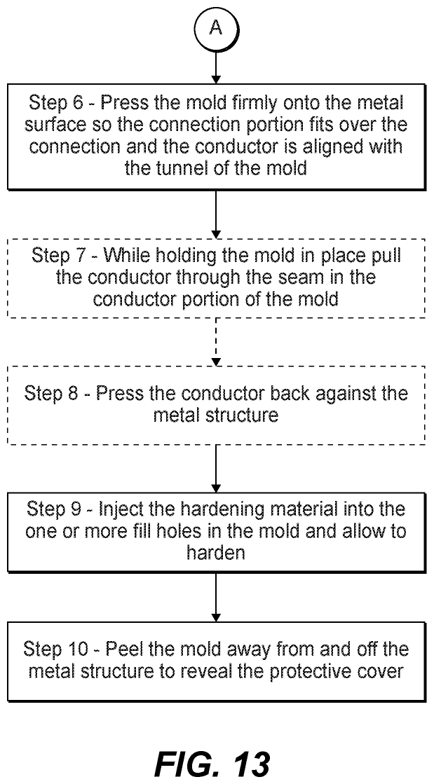

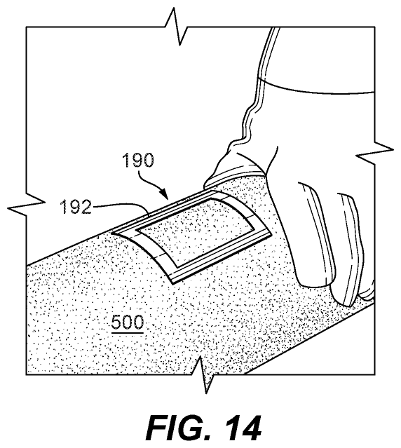

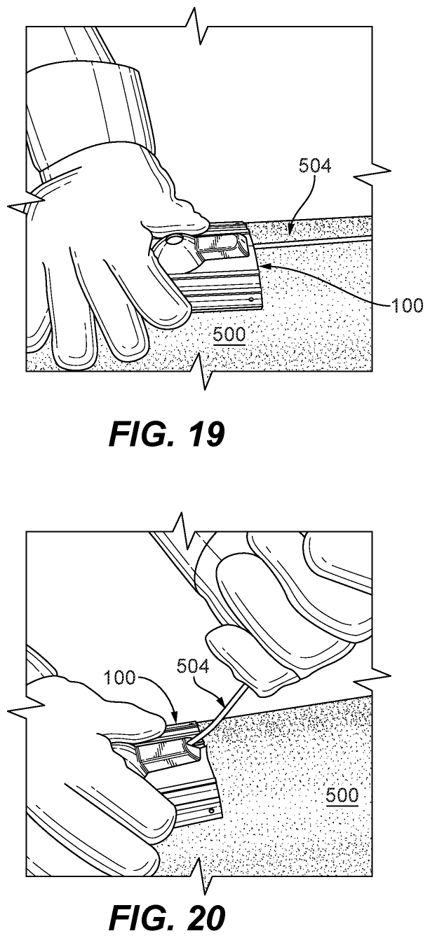

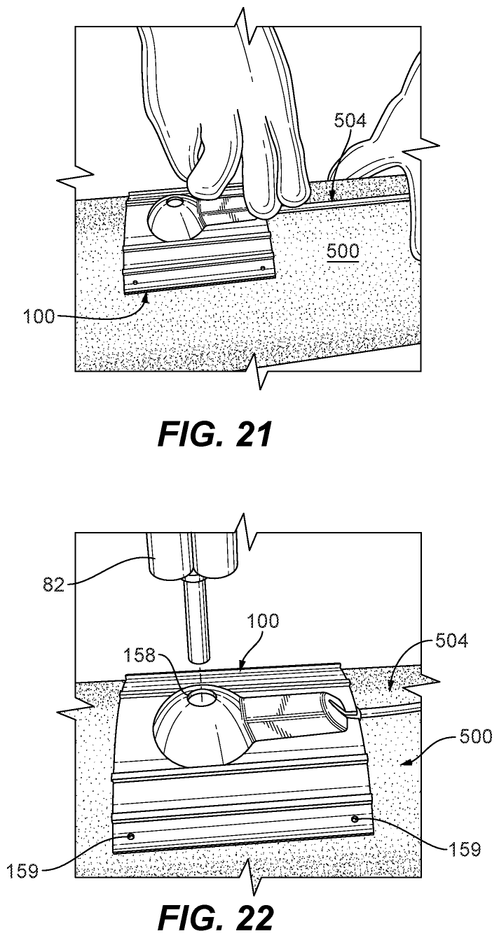

Referring now to FIGS. 11-23, an exemplary process for forming the protective covering of the present disclosure will be described. This exemplary process will be described using the mold 100 of FIGS. 6-10. Initially, the template 190 is attached to the metal structure in the desired location for the connection 502 and the protective covering 510, seen in FIG. 23. Lines may be drawn on the surface of the metal structure 500 outlining the outer perimeter of the outer border 192 of the template 190 and outlining the outer perimeter of the inner opening 194 of the template. The template may then be removed from the metal structure 500 (Step 1, FIGS. 12 and 14). In an alternative embodiment, the template 190 may be left in place while the surface of the metal structure 500 is being prepared to receive the exothermic connection. The surface of the metal structure 500 is then prepared to receive he exothermic connection (Step 2, FIGS. 12 and 15). For example, the surface of the metal structure 500 may be prepared using, for example, a bristle blaster, blasting material or sandpaper, until bare metal is exposed. With the surface of the metal structure 500 prepared, an exothermic or brazed connection can be made (Step 3, FIGS. 12 and 16). In this exemplary embodiment an exothermic connection is shown. To make the exothermic connection, an end of a conductor 504 is positioned within an exothermic welding mold 506. The exothermic welding mold 506 is positioned on the prepared portion, e.g., the bare metal, of the metal structure 500, and the exothermic reaction is initiated as is known. With the exothermic reaction completed, the exothermic welding mold 506 is removed to reveal the connection 502, e.g., an exothermic connection, seen in FIG. 17. Substances that may impede the adhesion of the mold 100 to the metal structure 500, such as residue from the exothermic reaction, debris or grease, are then removed from the area of the metal structure on which the mold 100 is to be adhered (Step 4, FIGS. 12 and 17). The substances can be removed by brushing with a wire brush or sanding with sandpaper. The release paper 30 on the lower surface 126 of the mold 100 is then removed to reveal the adhesive layer 128 on the lower surface 126 (Step 5, FIGS. 12 and 18). The mold 100 is positioned over the prepared area of the metal structure 500 so that the connection 502 is aligned with the cavity 156 in the connection portion 152 and the conductor 504 is aligned with the tunnel 162 on the conductor portion 154 of the fill housing 150. The mold 100 is then pressed onto the metal structure so that the adhesive layer 128 releasably adheres the mold 100 to the metal structure (Step 6, FIGS. 13 and 19). Optionally, the conductor 504 can be lifted so that it passes through the optional seam 170 in the conductor portion 154 of the fill housing 150 (Step 7, FIGS. 13 and 20). At this point, the conductor 504 extends from the cavity 156 through the tunnel 162 and exits the mold 100 via the seam 170. The lifted conductor 504 can then be pressed back against the metal structure 500 so that the conductor is in close proximity to the metal structure (Step 8, FIGS. 13 and 21). It is noted that lifting the conductor 504 through the seam 170 may provide a spacing between the metal structure 500 and the conductor 504 within the tunnel 162 to that when the hardening material 80 is injected into the fill housing 150, the hardening material encases the portion of the conductor within the tunnel 162.

The hardening material 80 is then injected into the one or more fills holes 158 in the connection portion 152 and/or the conductor portion 154 of the fill housing 150 using, for example, a push applicator 82 (Step 9, FIGS. 13 and 22). As the hardening material is being injected into the mold 100, air within the mold is released through the pressure relief holes 159 in the base 120. In the event the mold 100 is made of a transparent material, an installer can visually observe the hardening material being injected into the mold 100 to know when sufficient hardening material has been injected into the mold. In the event the mold 100 is made of a material that is not transparent, the pressure relief holes 159 included in the base 120 of the mold 100, may also act as an indicator that sufficient hardening material has been injected into the mold. More specifically, when the hardening material 80 is visible through the pressure relief holes 159, sufficient hardening material has been injected into the cavity 156, the tunnel 162 and the area under the base 120 of the mold 100 adjacent the outer perimeter of the base so that the hardening material is at least covering the bare metal exposed when preparing the surface of the metal structure 500 for the connection 502. Expanding the hardening material to the area under the base of the mold so that the hardening material at least covers the exposed bare metal replaces the coating on the surface of the metal structure 500 removed to make the connection 502. With the hardening material 80 injected into the fill housing 1.50, the hardening material is allowed to harden. With the hardening material 80 hardened, the mold 100 may be peeled away from the metal structure 500 by grasping the peel tab 123 extending from an edge of the base 120 to reveal the protective covering 510 (Step 10, FIGS. 13 and 23), or the mold 100 may be left in place on the metal structure 500.

Metal structures used in above ground and below ground outdoor environments typically include an outer coating of, for example, a fusion bonded epoxy or like material, that protects the metal structure from environment conditions, such as water and oxygen. In some instances, such outer coatings on the surface of the metal structures may be damaged, may not be uniform, may have cracks or holes or may be otherwise diminished (collectively “diminished coating”). The present disclosure also contemplates molds that can be used to repair diminished coatings on metal structures.

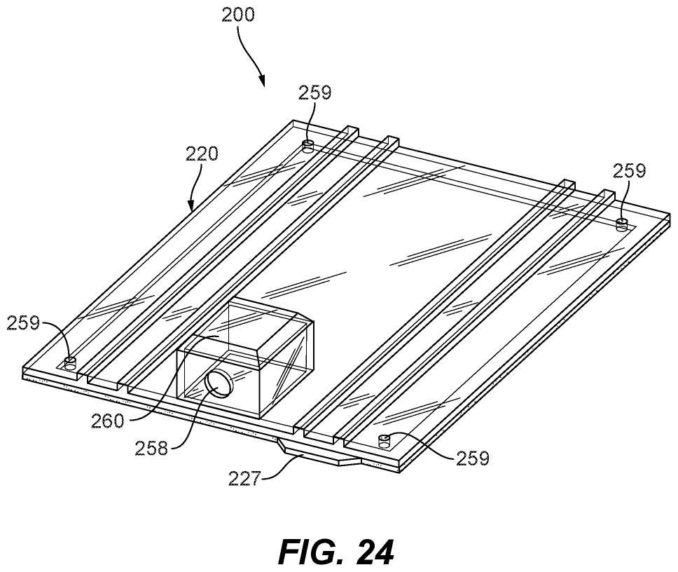

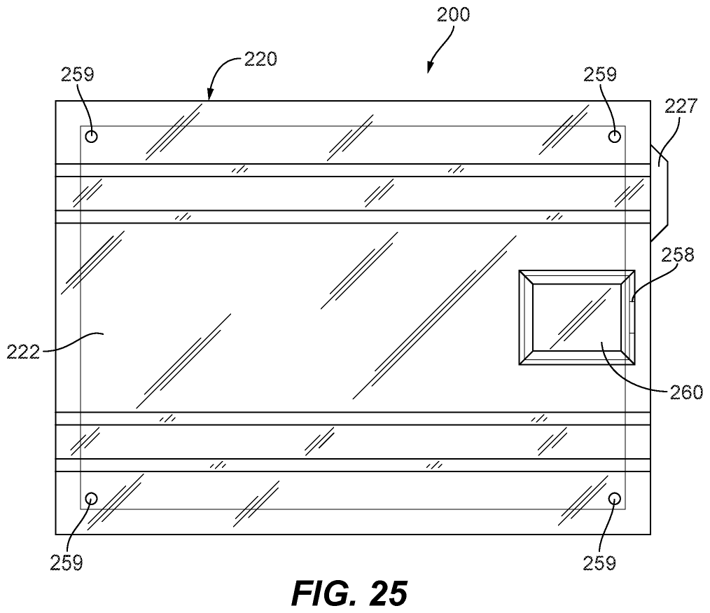

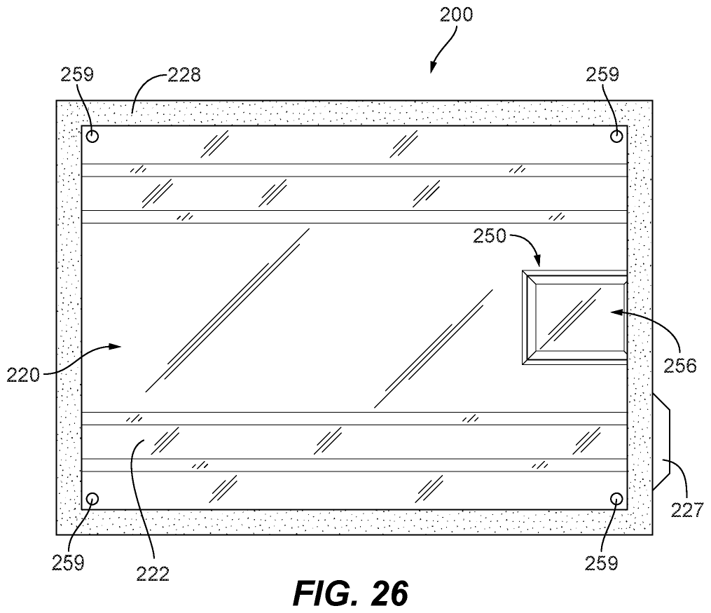

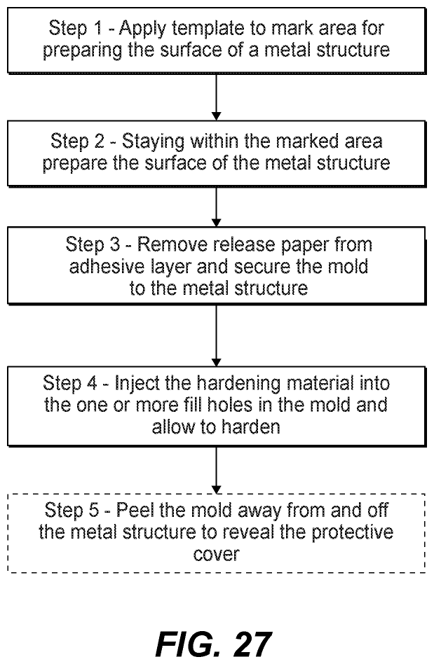

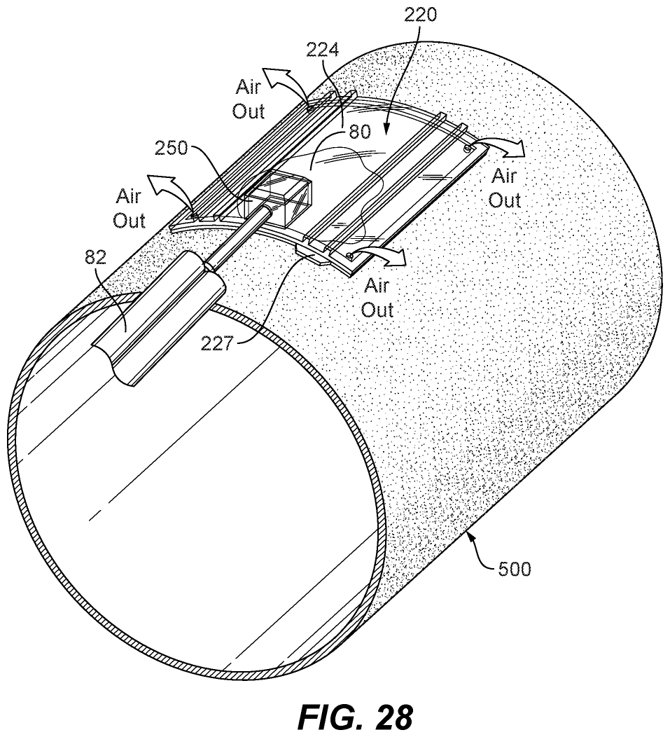

Referring to FIGS. 24-28, another exemplary embodiment of a mold according to the present disclosure is shown. The mold 200 includes a base 220 and a fill housing 250. The base 220 and fill housing 250 may be made of a plastic material, such as a plastic material that can be vacuum formed or thermoformed, including thermoplastic or thermo-softening plastic materials. Preferably, the base 220 and fill housing 250 are made of a transparent material so that an installer can visually observe the hardening material being injected into the mold 200. However, the base 220 and fill housing 250 can be made of a material that is not transparent. The base 220 is configured to rest on and releasably adhere to a surface of a metal structure 500, seen in FIG. 27. The base 220 may be in any suitable shape, such as a square shape, a rectangular shape, round shape, elliptical shape, oval shape, or any asymmetrical shape. Preferably, the base 220 is a flexible member that can be manipulated to conform at least partially to the shape of the structure 500 the base is to be releasably adhered to. In the exemplary embodiment shown, the base 220 is square in shape and can flex or bend to conform to the shape of a metal structure 500, here a pipe, as shown in FIG. 28. The base 220 has an upper surface 222 that may include one or more ribs 224 that provide flex lines or points on the base further permitting the base 220 to flex to conform to the shape of the structure 500. The one or more ribs 224 extend from one edge of the base 220 to an opposite edge of the base 220, as shown in FIG. 25. An outer edge of the base 220 may also include a pull tab 227 that can be used to pull the mold away from the metal structure 500 after the hardening material has hardened. The base 220 has a lower surface 226 that includes a layer 228, seen in FIG. 26, of adhesive at least around a perimeter of the base 220 and release paper, similar to the release paper 30 seen in FIG. 18, that covers the adhesive layer 228 until the mold 200 is ready for installation. The adhesive layer 228 should be sufficient to releasably adhere the mold 200 to the structure 500. In the exemplary embodiment shown, the width of the adhesive layer 228 is about 0.25 inch. However, the width of the adhesive layer 228 may vary. For example, the width of the adhesive layer 228 may be about 0.5 inch, 0.75 inch or 1 inch. Non-limiting examples of suitable adhesives for the adhesive layer include butyl adhesive tapes and double sided tapes. It is noted that the adhesive layer 228 may be replaced with a magnetic strip along the perimeter of the base 220 that releasably adheres the base to the metal surface. The width of the magnetic strip may vary. For example, the width of the magnetic strip may be about 0.5 inch, 0.75 inch or 1 inch. The base 220 may include one or more pressure release holes 259 at or near the outer perimeter of the base. The pressure release holes 259 are used as an air outlet so that as the hardening material is injected into the mold 200 and begins to fill the space or pocket between the mold and the structure 500, air can escape the space via the pressure relief holes 259. In instances where the mold 200 is made of a non-transparent material, the pressure relief holes 259 may also act as an indicator to provide an indication when the hardening material is fully injected into the fill housing 250 and a surrounding perimeter of the fill housing 250 covering the area of the structure 500 with the diminished coating.

Continuing to refer to FIGS. 24-28, the fill housing 250 of the mold 200 may be integrally or monolithically formed into the base 220. However, the fill housing 250 may be secured to the upper surface 222 of the base 220 using, for example, adhesives or welds, e.g., sonic welds. The fill housing 250 has one or more walls that form a cavity 256, seen in FIGS. 25 and 26, and one or more fill holes 258 in, for example, a top wall 260 of the fill housing that permit hardening material 80, seen in FIG. 27, to be injected into the cavity 256 of the fill housing 250 using for example the push applicator 82, seen in FIG. 22. It is noted that when the fill housing 250 is integrally or monolithically formed into the base 220, the cavity 256 is at the lower surface 226 of the base 220. When the fill housing 250 is secured to the upper surface 222 of the base 220, the base 220 would include an opening that preferably conforms to the cavity 256 so that the cavity 256 is accessible from the lower surface 226 of the base 220.

As noted above, the hardening materials contemplated by the present disclosure are preferably dielectric materials that include surface coating resins and like materials, including but not limited to liquid or near liquid adhesive materials. Non-limiting examples of such materials include epoxies, bituminous, asphaltic, polyethylene, synthetic rubbers and wax based materials that can be injected into the fill holes 258 in the fill housing 250 and then harden. An example of a suitable hardening material is the SP-2888®R.G. surface coating resin manufactured and sold by Specialty Polymer Coatings, Inc. of British Columbia, Canada.

Referring now to FIGS. 27 and 28, an exemplary process for patching a coating on an metal structure will be described. This exemplary process will be described using the mold 200 of FIGS. 24-26. Initially, the template 190, seen in FIG. 11, is attached to the metal structure in the desired location for patching the coating on the metal structure and marking the area of the coating to be patched, Step 1. In an alternative embodiment, the template 190 may be left in place while the coating on the metal structure 500 is being prepared to receive the mold 200 and the exothermic connection. The coating on the metal structure 500 is then prepared to receive the hardening material using, for example, sandpaper, blasting material or a bristle blaster. With the surface of the metal structure 500 prepared, the release paper is removed from the adhesive layer 228. The mold 200 is positioned over the prepared area of the metal structure 500 and pressed onto the metal structure so that the adhesive layer 128 releasably adheres the mold 200 to the metal structure (Step 3). The hardening material 80 is then injected into the one or more fills holes 258 in the fill housing 250 using, for example, a push applicator 82 (Step 4). As the hardening material is being injected into the mold 200, air within the mold is released through the pressure relief holes 259 in the base 220. In the event the mold 100 is made of a transparent material, an installer can visually observe the hardening material being injected into the mold 200 to know when sufficient hardening material has been injected into the mold. In the event the mold 200 is made of a material that is not transparent, the pressure relief holes 259 included in the base 220 of the mold 200, may also act as an indicator that sufficient hardening material has been injected into the mold. More specifically, when the hardening material 80 is visible through the pressure relief holes 259, sufficient hardening material has been injected into the fill housing 250 and the area under the base 220 of the mold 200 adjacent the outer perimeter of the base so that the hardening material is at least covering the diminished area of the coating on the metal structure 500. With the hardening material 80 injected into the fill housing 250, the hardening material is allowed to harden. With the hardening material 80 hardened, the mold 200 may be peeled away from the metal structure 500 by grasping the peel tab 227 extending from an edge of the base 220 to reveal the protective covering, or the mold. 100 may be left in place on the metal structure 500.

While illustrative embodiments of the disclosure have been described and illustrated above, it should be understood that these are exemplary of the disclosure and are not to be considered as limiting. Additions, deletions, substitutions, and other modifications can be made without departing from the spirit or scope of the disclosure. Accordingly, the disclosure is not to be considered as limited by the foregoing description.

What is claimed is:

1. A method for forming a protective covering over a connection between a conductor and a metal structure comprising:
adhering a mold to the metal structure so that the connection is positioned within a cavity of a fill housing of the mold and the conductor passes through a tunnel in the mold and exits the mold;
injecting a hardening material into the fill housing of the mold through at least one fill hole in the fill housing so that the hardening material fills the cavity and the tunnel; and
allowing the hardening material to harden to form the protective covering.

2. The method according to claim 1, further comprising removing the mold from the hardened hardening material.

3. The method according to claim 1, wherein the hardening material is injected using a push applicator.

4. The method according to claim 1, wherein the mold includes a base and the fill housing is integrally formed into the base or secured to the base.

5. The method according to claim 4, wherein the base includes an adhesive layer, such that the adhesive layer adheres the mold to the metal structure.

6. The method according to claim 4, wherein the base includes a magnetic layer, such that the magnetic layer adheres the mold to the metal structure.

7. A mold for forming a protective covering over a connection between a conductor and a metal structure, the mold comprising:
a base;
a fill housing extending from the base, the fill housing having a connector portion and a conductor portion, the connector portion having a cavity configured to receive the connection between the conductor and the metal structure, the conductor portion having a tunnel configured to receive the conductor extending from the connection.

8. The mold according to claim 7, wherein the base is made of a flexible material so that the base can flex to conform substantially to the shape of the metal structure.

9. The mold according to claim 7, wherein the base includes at least one ribs extending from one edge of the base to an opposite edge of the base, the at least one ribs providing a flex line permitting the base to flex to conform substantially to the shape of the metal structure.

10. The mold according to claim 7, wherein the base has one of a square shape, a rectangular shape, a round shape, an elliptical shape, an oval shape or an asymmetrical shape.

11. The mold according to claim 7, wherein the base has at least one full indicator hole positioned near an outer edge of the base.

12. The mold according to claim 7, wherein the connector portion of the fill housing includes at least one fill hole.

13. The mold according to claim 7, wherein the conductor portion of the fill housing includes a front wall having a seam that can separate to permit the conductor to pass from the tunnel out of the conductor portion.

14. The mold according to claim 7, wherein the conductor portion of the fill housing includes a front wall having an angle relative to a top surface of the base.

15. A mold for forming a protective covering over a connection between a conductor and a metal structure, the mold comprising:
a base having an upper surface and a lower surface;
a fill housing extending from the upper surface of the base and monolithically formed into the base, the fill housing having a connector portion and a conductor portion, the connector portion having a cavity accessible from the lower surface of the base and configured to receive the connection between the conductor and the metal structure, the conductor portion having a tunnel accessible from the lower surface of the base and in communication with the cavity, the conductor portion being configured to receive the conductor extending from the connection.

16. The mold according to claim 15, wherein the base is made of a flexible material so that the base can flex to conform substantially to the shape of the metal structure.

17. The mold according to claim 15, wherein the upper surface of the base includes at least one rib extending from one edge of the base to an opposite edge of the base, the at least one rib providing a flex line permitting the base to flex to conform substantially to the shape of the metal structure.

18. The mold according to claim 15, wherein the base has one of a square shape, a rectangular shape, a round shape, an elliptical shape, an oval shape or an asymmetrical shape.

19. The mold according to claim 15, wherein the base has at least one full indicator hole positioned near an outer edge of the base.

20. The mold according to claim 15, wherein the connector portion of the fill housing includes at least one fill hole.

21. The mold according to claim 15, wherein the conductor portion of the fill housing includes a front wall having a seam that can separate to permit the conductor to pass from the tunnel out of the conductor portion.

22. The mold according to claim 15, wherein the conductor portion of the fill housing includes a front wall having an angle relative to a top surface of the base.

23. A mold for forming a protective covering over a metal structure, the mold comprising:
a base having an upper surface and a lower surface;
a fill housing extending from the upper surface of the base and monolithically formed into the base, the fill housing having a fill opening accessible from the upper surface of the base for receiving a hardening material application and accessible from the lower surface of the base.
